(19) United States
(12) Patent Application Publication
(10) Pub. No.: US 2024/0128007 A1
(43) Pub. Date: Apr. 18, 2024

(54) ELECTRICAL DEVICE

(71) Applicant: Murata Manufacturing Co., Ltd., Nagaokakyo-shi (JP)

(72) Inventor: Kapila WARNAKULASURIYA, Milton Keynes (GB)

(21) Appl. No.: 18/392,298

(22) Filed: Dec. 21, 2023

Related U.S. Application Data
(63) Continuation of application No. PCT/GB2022/051644, filed on Jun. 27, 2022.

(30) Foreign Application Priority Data
Jun. 29, 2021 (GB) 2109361.2

(51) Int. Cl. H01F 27/02; H01F 27/28

(52) U.S. Cl. CPC H01F 27/025; H01F 27/2876

(57) ABSTRACT

An electrical device includes a thermally insulating layer including first and second opposing surfaces. The first surface of the thermally insulating layer is on a first surface of the electrical device. A thermally conductive layer is on the second surface of the thermally insulating layer. The electrical device further includes one or more thermal conductors in thermal contact with the thermally conductive layer to transfer heat away from the thermally conductive layer via one or more coolers provided externally to the electrical device. Such a composite layer arrangement maintains a temperature of a surface at a low value, allowing low temperature rated electronic components to be mounted directly onto the electrical device.

### CROSS REFERENCE TO RELATED APPLICATIONS

This application claims priority to United Kingdom Patent Application No. 2109361.2 filed on Jun. 29, 2021 and is a Continuation Application of PCT Application No. PCT/GB2022/051644 filed on Jun. 27, 2022. The entire contents of each application are hereby incorporated herein by reference.

### BACKGROUND OF THE INVENTION

### 1. Field of the Invention

This application relates to electrical devices, in particular to transformers or inductors, with a first surface temperature maintained at a low level through the use of a composite material surface.

### 2. Description of the Related Art

Recently developments have been made in the field of high-power, high-frequency (HPHF) transformers. For example, Murata Manufacturing Co., Ltd.'s pdqb winding technology (as described in UK patent publication GB2574481) makes it possible to achieve the theoretically minimum level of high-frequency conductor losses in HPHF transformers. Furthermore, Murata Manufacturing Co., Ltd.'s thermal management approaches (as disclosed in UK patent applications GB2011332.0 and GB2011747.9) make it possible to extract heat generated in the compact transformer structures effectively.

However, certain applications require a low surface temperature to be maintained on particular areas of the transformer, such as the top surface of the transformer. For example, due to space constrains in the final product assembly, it is often necessary to mount low temperature rated electronic components directly on top of the transformer. Maintaining the surface temperature of HPHF transformers is a challenging task due to the amount of heat generated, even under normal operating conditions, for example, at power levels such as 50 kW or 100 kW.

Various external cooling structures for transformers are known; however, these typically include all metal casings that extract heat from the interior of the device, leading to a surface temperature that stays at a high level.

It would be desirable to provide a cooling arrangement of an electrical device such as a transformer that allows a low temperature to be maintained at particular portion or portions of the surface of the electrical device.

### SUMMARY OF THE INVENTION

The example embodiments of the present invention allow a chosen surface or surfaces of electrical devices to be maintained with a low surface temperature by using a composite layer arrangement. A thermally insulating layer and a thermally conductive layer in the composite layer ensure the surface temperature does not increase significantly due to heat generated in the interior of the electrical device, even during operation of the electrical device. Maintaining the surface temperature of the electrical device at a low value allows low temperature rated electronic components to be mounted directly onto the electrical device, which provides a more versatile and space efficient device.

According to an example embodiment of the present invention, an electrical device includes a thermally insulating layer including a first surface and a second surface opposing the first surface, the first surface of the thermally insulating layer being located on a first surface of the electrical device; a thermally conductive layer on the second surface of the thermally insulating layer; and one or more thermal conductors in thermal contact with the thermally conductive layer to transfer heat away from the thermally conductive layer via one or more coolers external to the electrical device. The electrical device is a transformer or an inductor.

The one or more coolers can include a cooling plate on a second surface of the electrical device. At least one of the one or more thermal conductors can be in thermal contact with the cooling plate to conduct heat away from the thermally conductive layer to the cooling plate. The second surface of the electrical device can oppose the first surface of the electrical device. The one or more thermal conductors can be positioned on one or more surfaces of the electrical device that extend between the first surface and the second surface of the electrical device. The one or more thermal conductors can include two thermal conductors on opposing surfaces of the electrical device that both extend between the first surface and the second surface. The electrical device and/or at least one of the one or more thermal conductors can include one or more mounts to fix the electrical device on the cooling plate.

At least one of the one or more thermal conductors can include one or more radiating fins. The one or more coolers can include a cooling fan to provide an air flow over the one or more radiating fins. The one or more thermal conductors can be positioned on one or more surfaces of the electrical device that extend perpendicularly or substantially perpendicularly away from the first surface of the electrical device.

The electrical device can further include an additional thermally insulating layer including a first surface and a second surface opposing the first surface, the first surface of the additional thermally insulating layer being located on a third surface of the electrical device; and an additional thermally conductive layer on the second surface of the additional thermally insulating layer. The additional thermally conductive layer can be in thermal contact with the one or more thermal conductors and/or one or more additional thermal conductors to transfer heat away from the additional thermally conductive layer.

The electrical device can have a cuboid or cube shape. The thermally insulating layer can be equal in size to or larger in size than the thermally conductive layer. The thermally insulating layer and the thermally conductive layer can substantially cover an entirety of the first surface of the electrical device. The thermally conductive layer and/or the one or more thermal conductors can include a metal, a non-magnetic metal, aluminum, or copper. The thermally conductive layer can be thinner than at least one of the one or more thermal conductors. The thermally insulating layer can be electrically insulating. The thermally insulating layer can include at least one of plastic, fiberglass, resin, or a glass-reinforced epoxy laminate. The electrical device can include a high-power, high-frequency transformer.

The electrical device can further include a core assembly and can further include one or more thermally conductive plates within the core assembly to transfer heat away from the interior of the core assembly.

The electrical device can further include a winding assembly and can further include one or more thermally conductive plates within the winding assembly to transfer heat away from the winding assembly.

According to an example embodiment of the present invention, a housing for an electrical device includes a first surface including a thermally insulating layer including a first surface and a second surface opposing the first surface and a thermally conductive layer on the second surface of the thermally insulating layer, and includes one or more thermal conductors in thermal contact with the thermally conductive layer to transfer heat away from the thermally conductive layer via a cooler external to the electrical device. The housing is structured to accommodate the electrical device, with the first surface of the thermally insulating layer against a first surface of the electrical device; and the electrical device is a transformer or an inductor.

The above and other elements, features, steps, characteristics, and advantages of the present invention will become more apparent from the following detailed description of the example embodiments with reference to the attached drawings.

### BRIEF DESCRIPTION OF THE DRAWINGS

FIG. 1 shows an exploded view of an electrical device of a first example embodiment of the present invention.

FIG. 2 shows a perspective view of the electrical device of the first example embodiment of the present invention.

FIG. 3 shows a cross section of the electrical device of the first example embodiment of the present invention.

FIG. 4 shows a plan view of the electrical device of the first example embodiment of the present invention.

FIG. 5 shows a perspective view of an electrical device of a second example embodiment of the present invention.

FIG. 6 shows a perspective view of an electrical device of a third example embodiment of the present invention.

FIG. 7 shows a perspective view of an electrical device of a fourth example embodiment of the present invention.

FIG. 8 shows an interior structure that may be used in the electrical devices of the first, second, third, and fourth example embodiments of the present invention.

FIG. 9 shows a partial view of the interior structure of FIG. 8.

FIG. 10 shows an interior structure that may be used in the electrical devices of the first, second, third, and fourth example embodiments of the present invention.

FIG. 11 shows an interior structure that may be used in the electrical devices of the first, second, third, and fourth example embodiments of the present invention.

FIG. 12 shows an interior structure that may be used in the electrical devices of the first, second, third, and fourth example embodiments of the present invention.

FIG. 13 shows a partial view of the interior structure of FIG. 12.

FIG. 14 shows an interior structure that may be used in the electrical devices of the first, second, third, and fourth example embodiments of the present invention.

### DETAILED DESCRIPTION OF THE EXAMPLE EMBODIMENTS

Example embodiments of the present invention provide electrical devices each including a transformer or an inductor. An electrical device according to an example embodiment of the present invention may include a thermally insulating layer including first and second opposing surfaces, the first surface of the thermally insulating layer being located on a first surface of the electrical device. A thermally conductive layer may be located on the second surface of the thermally insulating layer. The electrical device further includes one or more thermally conductive portions or thermal conductors that are in thermal contact with the thermally conductive layer to transfer heat away from the thermally conductive layer via one or more coolers or cooling structures provided externally to the electrical device. This composite layer arrangement maintains the temperature of the chosen surface at a low value, allowing low temperature rated electronic components to be mounted directly onto the electrical device.

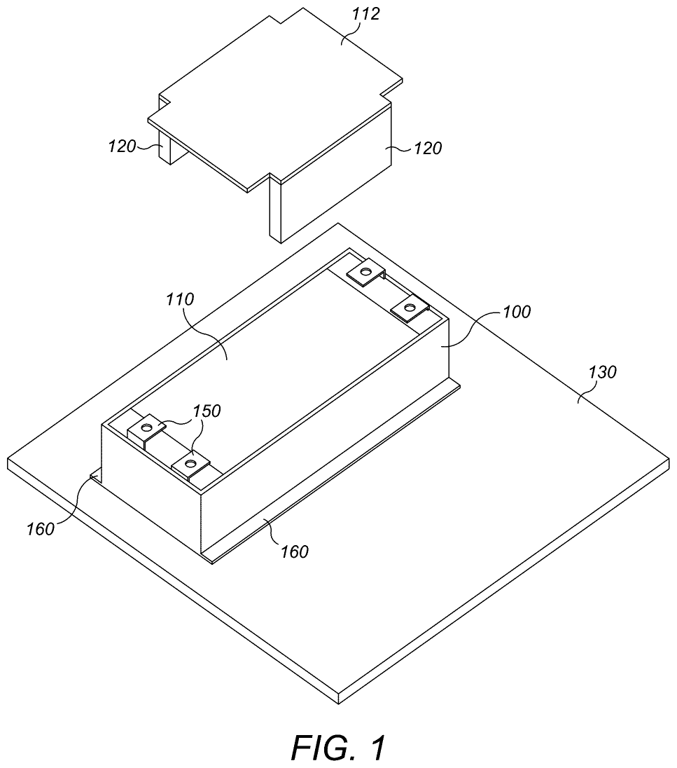

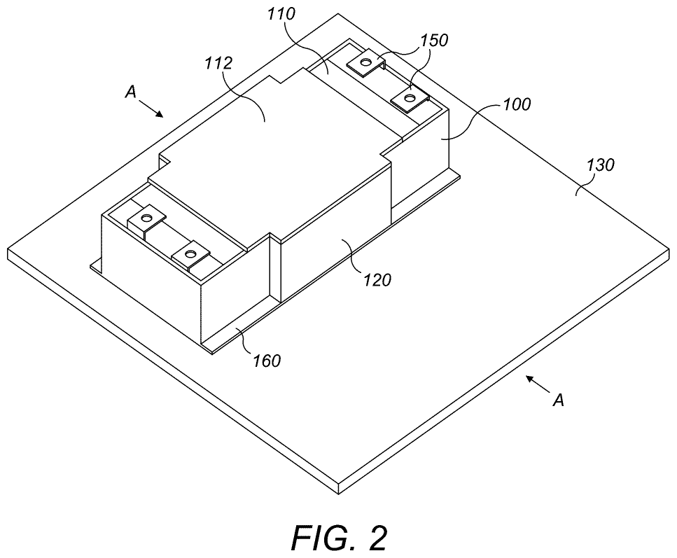

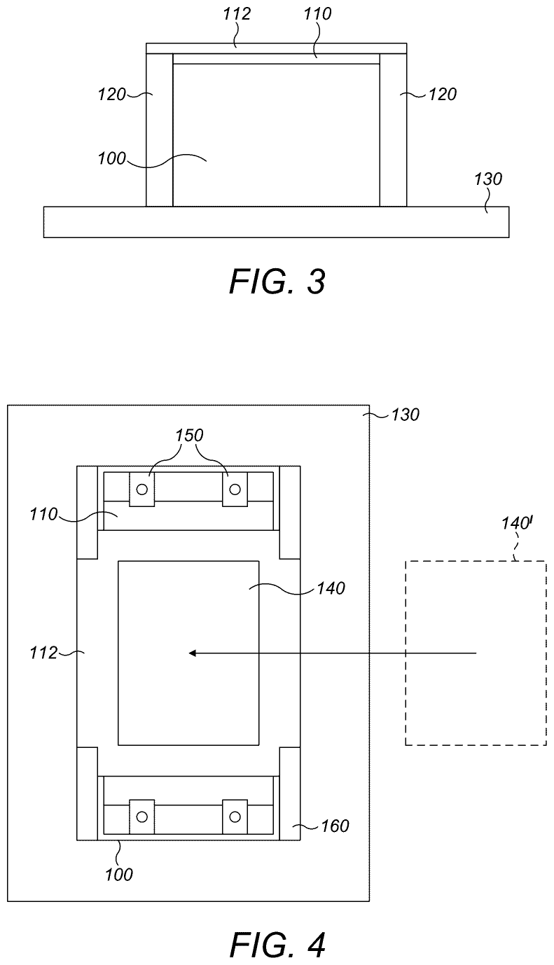

FIGS. 1 and 2 show an exploded and a perspective view of an electrical device 100 of a first example embodiment of the present invention. FIG. 3 shows a cross section of the electrical device 100 of the first example embodiment, through plane A marked in FIG. 2. The internal details of the electrical device 100, such as a core or windings, have been omitted in FIG. 3.

In the present example embodiment, the electrical device 100 includes a transformer. In particular, the electrical device 100 is a high-power, high-frequency (HPHF) transformer, such as a Murata Manufacturing Co., Ltd. pdqb type transformer, as described in UK patent publication GB2574481, which is incorporated in its entirety herein by reference. However, any type of transformer may be used. Moreover, in alternative example embodiments, an inductor such as a high-power inductor may be used as the electrical device 100.

In the first example embodiment a first surface (also referred to as the first side) of the electrical device 100 is maintained at a low surface temperature. In the present example embodiment, the first surface is a top surface of the electrical device 100, meaning the electrical device 100 can be described as a “cold top” transformer. However, any surface of the transformer could be chosen as the surface to maintain at a low temperature. Maintaining at a low temperature means reducing or minimizing the increase in surface temperature when the electrical device 100 is operating compared to an ambient surface temperature before operation of the electrical device 100.

The surface temperature of first surface of the electrical device 100 is maintained at a low level through the use of a composite material top surface. The composite layer arrangement includes a thermally insulating layer 110 and a thermally conductive layer 112. The thermally insulating layer 110 includes first and second opposing surfaces or sides. The first side of the thermally insulating layer 110 is disposed on the first side of the electrical device 100. The thermally conductive layer 112 is then disposed on the second side of the thermally insulating layer 110. In other words, the thermally conductive layer 112 is layered or stacked on top of the thermally insulating layer 110.

When the electrical device 100 is operated, heat is generated, for example, in the core and windings of the transformer. The composite layer prevents the internally generated heat from increasing the surface temperature of the first surface by an unacceptable amount. The thermally insulating layer 110 provides a high thermal resistance that minimizes the amount of heat transfer from the core of the electrical device 100 through the thermally insulating layer 110 towards the first surface, for example, in the upwards direction. The thermally insulating layer 110 is unlikely to be a perfect insulator; therefore, some heat transfer will still occur towards the first surface. Any heat that does pass through the thermal insulating layer 110 will therefore transfer into the thermally conductive layer 112.

The thermally conductive layer 112 is in thermal contact with one or more thermally conductive portions or thermal conductors 120, which extract the heat energy from the thermally conductive layer 112 via conduction, and transfer the heat out of the thermally conductive layer 112 and away from the first surface. The composite layer of the thermally insulating layer 110 and thermally conductive layer 112 therefore both prevents heat transfer towards the first surface and enables removal of heat which does pass through the thermally insulating layer 110 towards the first surface. The increase in surface temperature on the first surface above the thermally insulating layer 110 and thermally conductive layer 112 is therefore greatly reduced during operation of the electrical device 100.

There are many possible configurations for the one or more thermally conductive portions 120. In the present example embodiment, the electrical device 100 is a cuboid shape, and there are two thermally conductive portions 120 which are positioned on opposing sides of the electrical device 100 that extend perpendicularly or substantially perpendicularly, within manufacturing and/or measurement tolerances, away from the first side of the electrical device 100. The thermally conductive portions 120 are configured or suitable to transfer heat away from the thermally conductive layer 112 via one or more coolers 130 provided externally to the electrical device 100. In the present example embodiment, there is one cooler 130 which is disposed on a second side of the electrical device 100, i.e., the second side opposing the first side of the electrical device 100. The cooler 130 is a cooling plate or cold plate, for example, a liquid-cooled cold plate. The thermally conductive portions 120 are in thermal contact with the cooler 130 to conduct heat away from the thermally conductive layer 112 to the cooler 130.

In the above-described configuration, heat produced in the interior of the electrical device 100 mainly flows in the downwards direction in FIG. 3 towards the cooler 130, due to the thermally insulating layer 110 preventing heat transfer in the upwards direction towards the first surface. Any heat which does pass up through the thermally insulating layer 110 towards the first surface is efficiently extracted from the thermally conductive layer 112 via conduction through the thermally conductive portions 120 and onto the cooler 130. Therefore, a temperature rise on the first surface of the electrical device 100 (the outer surface of the thermally conductive layer 112) is prevented. For example, a temperature rise of less than 10 degrees on the first surface has been observed using the configuration of the first example embodiment, even for a transformer delivering a high power, such as about 50 kW, for example.

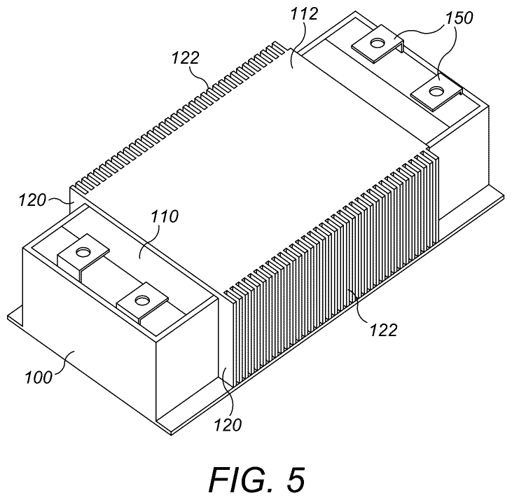

Ensuring that the chosen first surface of the electrical device 100 does not experience a large temperature increase results in a more versatile and adaptable device. For example, controlling the temperature increase on the top surface in this example embodiment means temperature sensitive components can be mounted directly on top of the electrical device 100. As demonstrated by FIG. 4, this can provide a large space saving, by reducing the overall footprint of the implementation of the electrical device. FIG. 4 shows a plan view of the electrical device 100 of the first example embodiment mounted on a cooler 130, with the thermally insulating layer 110 and thermally conductive layer 112 disposed on the first side of the electrical device 100, and an additional component 140 mounted on top of the thermally conductive layer 112. The dashed box 140′ in FIG. 4 gives an example a location where the additional component 140 would be located for conventional devices that do not allow direct mounting on top of the device, due to large increases in surface temperature that would damage the additional component 140. The footprint of a system when the additional component 140 is located in the dashed box 140′ is much greater.

The additional component 140 may be, for example, a circuit board, a control circuit, an additional transformer or inductor, or electronics intended to be used with the electrical device 100. In some example embodiments, the additional component 140 may be connected to the input/output terminals 150 of the electrical device 100. Moreover, the additional component 140 may be mounted onto the thermally conductive layer 112 in various ways, including but not limited to adhesive, pins, screws, clips, or the like. In some example embodiments, additional electrical or thermal insulation may be disposed between the thermally conductive layer 112 and the additional component 140. In some example embodiments, the additional component 140 could be separated from the thermally conductive layer 112, through the use of pegs, spacers, legs, or the like. In other words, the additional component 140 may be raised above or thermally conductive layer 112, with an air gap left therebetween. This can provide further thermal protection for the additional component 140.

Although the above-described first example embodiment includes two thermally conductive portions 120, any number of thermally conductive portions 120 may be used. For example, there may only be one thermally conductive portion 120 connecting the thermally conductive layer 112 and the cooler 130, or a plurality of thermally conductive portions 120 may connect the thermally conductive layer 112 and the cooler 130. The one or more thermally conductive portions 120 may each be positioned on any of the sides of the electrical device 100 that extend away from the first side. In the first example embodiment, where the second side that the cooler 130 is disposed against is opposite to the first side, the one or more thermally conductive portions 120 may each be positioned on any of the sides of the electrical device 100 that extend between the first side and the second side of the electrical device 100. In the present example embodiment, the thermally conductive portions 120 are shown disposed on opposing sides; however, the thermally conductive portions 120 could instead be disposed on two adjacent sides of the electrical device 100. In some example embodiments, thermally conductive portions 120 could be positioned on three or even all four of the sides extending between the first side and the second side of the electrical device 100.

In the first example embodiment, as shown in FIG. 2, the thermally conductive portions 120 are square, substantially square, rectangular, or substantially rectangular plates that extend over the full height of the electrical device 100 between the first and second sides, but extend only partially along the width of the electrical device 100 (the width of the device here being the direction parallel to the planes of both the thermally conductive layer 112 and thermally conductive portions 120 shown in FIG. 2). However, in some example embodiments, the thermally conductive portions 120 could extend to cover the entirety of the width of the electrical device 100. In other words, each thermally conductive portion 120 could cover the entirety of the side of the device that it is mounted on. Various differently shaped thermally conductive portions 120 could be used, with the shape chosen being a result of a trade-off between better thermal performance for larger thermally conductive portions, and more weight and expense when additional material is used for each thermally conductive portion.

Similarly, the size and shape of each of the thermally insulating layer 110 and thermally conductive layer 112 can be modified, in order to achieve different temperature profiles for the first surface. Although in the first example embodiment the thermally insulating layer 110 and thermally conductive layer 112 only extend over a portion of the first surface, in alternative example embodiments, the thermally insulating layer 110 and thermally conductive layer 112 could extend over the entirety of the first surface of the electrical device 100. Again, considerations are based on the desired thermal properties compared to the additional weight and cost of additional material.

The size of the thermally conductive layer 112 may be chosen based on shape and size of the additional component 140 to be mounted onto the first surface of the electrical device 100. Typically, the thermally insulating layer 110 is equal in size to or larger in size than the thermally conductive layer 112. This ensures that thermal insulation is located at every point between the thermally conductive layer 112 and the electrical device 100, to ensure as much heat as possible is prevented from reaching the thermally conductive layer 112 and therefore the first surface.

In one specific example embodiment, all four sides between the first and second side of the electrical device 100 could each be covered entirely by a thermally conductive portion 120, and the entirety of the first side of the electrical device 100 could be covered by the thermally insulating layer 110 and thermally conductive layer 112. In other words, the thermally conductive portions 120 in combination with the thermally insulating layer 110 and thermally conductive layer 112 could form a closed housing or box around the electrical device 100, with only the second side of the electrical device 100 remaining uncovered and able to be disposed against a cooling plate as the cooler 130.

In the first example embodiment, the thermally conductive portions 120 are thicker than the thermally conductive layer 112. Increasing the thickness of the thermally conductive portions 120 increases the thermal conductance, increasing the flow of heat from the thermally conductive layer 112 to the cooler 130. A practical limit to the thickness of the thermally conductive portions 120 is chosen based on cost and weight, as well as thermal performance. The thermally conductive layer 112 is chosen to be thinner in order to reduce the height of the electrical device 100, and provide more room for mounting the additional component 140. Again, there is a trade-off between reducing the height of the device, and maintaining good thermal performance.

The thermally conductive layer 112 and thermally conductive portions 120 may be made out of any thermally conductive material, meaning a material with a high thermal conductivity. For example, the thermally conductive layer 112 may be made of any metal, including, for example, a non-magnetic metal, or at least one of aluminum or copper. Non-magnetic metals such as aluminum and copper have a high thermal conductivity, while being non-magnetic so as to not disrupt the magnetic properties of the electrical device 100, for example, if the electrical device 100 includes a transformer. The thermally conductive layer 112 and thermally conductive portions 120 may be made out of the same materials as each other, or different materials.

The thermally insulating layer 110 may be made out of any thermally insulating material, meaning a material with a low thermally conductivity. In some example embodiments, the thermally insulating layer 110 may also be a material that is electrically insulating, meaning a material with a low electrical conductivity. For example, the thermally insulating layer 110 may include at least one of the following materials: plastic, fiberglass, resin, or a glass-reinforced epoxy laminate. The thermally insulating layer 110 may consist entirely of one of these materials, or may be formed from a composite of more than one of these materials. In certain example embodiments, the thermally insulating layer 110 may be made out of FR-4 or G-11 (using the National Electrical Manufacturers Association, NEMA, grade designations for glass-reinforced epoxy laminate materials). The thermally insulating layer 110 may be formed as a sheet material that is overlaid on to the first surface of the electrical device 100, or may be a coating which is applied to the first surface of the electrical device 100, or the like. The lower thermally conductivity of the thermally insulating layer 110, the lower the increase in the temperature of the thermally conductive layer 112, and therefore the first surface, when the electrical device 100 is operated. When the thermally insulating layer 110 is also electrically insulating, any unwanted circulating current paths are prevented from being created, for example, due to the leakage flux in the case of a transformer.

Although in the above described first example embodiment the electrical device 100 has a cuboid shape, variously shaped electrical devices may be used. For example, the electrical device may be a cube, cylinder, parallelepiped, or any type of prism. Taking the example of a cylindrical electrical device, the circular end faces of the cylinder could be the first and second sides of the electrical device, with the thermally insulating layer 110 and thermally conductive layer 112 disposed on the first side, and the second side positioned against a cooler 130 such as a cooling plate. The one or more thermally conductive portions 120 may then extend in a longitudinal direction along the surface of the cylinder between the circular end faces, to allow heat transfer between the thermally conductive layer 112 and the cooler 130.

In the case of the first example embodiment when the cooler 130 is a cooling plate, the electrical device 100 may include one or more mounting elements configured or suitable for mounting the electrical device onto the cooler 130, with the second side of the electrical device 100 positioned against the cooler 130. The cooler 130 may therefore be provided separately from the electrical device 100, with the electrical device 100, the thermally insulating layer 110, the thermally conductive layer 112, and the thermally conductive portions 120 all mounted onto the cooler 130 together during installation.

In the first example embodiment, the mounting elements are a pair of flanges 160 on the electrical device which are fixed against the cooler 130, for example, by screws, clips, nails, bolts, adhesive, or the like (not shown). The thermally conductive portions 120 are then also positioned against the cooler 130, to allow thermal conduction between the thermally conductive portions 120 and the cooler 130. In alternative example embodiments, mounting elements may additionally or alternatively be included as a portion of the thermally conductive portions 120, and may facilitate the thermal contact between the thermally conductive portions 120 and the cooler 130. In any case, the mounting elements may be, for example, screws, clips, nails, bolts, flanges, thermally conductive adhesives, or the like. Whatever configuration of mounting elements are used, once mounted, the second side of the electrical device 100 is positioned against the cooler 130, to allow heat to be transferred out of the interior of the electrical device 100 to the cooler 130 through the second side (e.g., the bottom of the device in the case of the first example embodiment). Once mounted, the thermally conductive portions 120 are also in thermal contact with the cooler 130 to allow heat to be removed from the thermally conductive portions 120 and therefore from the thermally conductive layer 112.

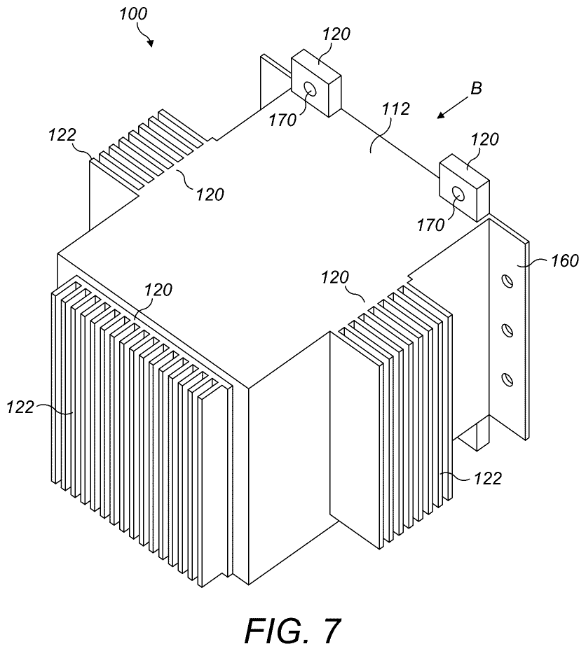

Although in the first example embodiment the cooler 130 is positioned on a second side of the electrical device 100 that opposes the first side of the electrical device 100 with the thermally insulating layer 110 and the thermally conductive layer 112, in alternative example embodiments, the cooler 130 may be positioned against alternative sides of the electrical device 100. For example, the cooler 130 could be disposed against the sides which are adjacent to and extending perpendicularly or substantially perpendicularly, within manufacturing and/or measurement tolerances, from the first side. An example of this will be discussed in more detail in relation to FIG. 7 below. Moreover, in some example embodiments, multiple coolers 130, e.g., multiple cooling plates, may be disposed against different sides of the electrical device 100.

Through the above-described first example embodiment, a chosen first surface of an electrical device 100 may be maintained with a low surface temperature using the described composite layer arrangement, even during operation of the electrical device 100. Maintaining the surface temperature of the electrical device 100 at a low value allows low temperature rated electronic components to be mounted directly onto the electrical device 100, which provides a more versatile and space efficient device.

The example embodiments of the present invention are not limited to cold-plate-mounted electrical devices; natural- or forced-air-cooled electrical devices are also possible. FIG. 5 shows a perspective view of an electrical device 100 of a second example embodiment of the present invention. The second example embodiment also includes an electrical device 100 with a thermally insulating layer 110 and a thermally conductive layer 112 disposed on a first surface of the electrical device 100. These features are analogous to the corresponding components in the first example embodiment, and a repeat of the description of these features will therefore be omitted.

The electrical device 100 of the second example embodiment also includes one or more thermally conductive portions 120 in thermal contact with the thermally conductive layer 112. The one or more thermally conductive portions 120 may each be positioned on any of the sides of the electrical device 100 that extend away from the first side. In the second example embodiment, two thermally conductive portions 120 are included on opposing sides of the electrical device 100 which extend perpendicularly or substantially perpendicularly, within manufacturing and/or measurement tolerances, from the first side.

In the second example embodiment, each of the thermally conductive portions 120 includes one or more radiating fins 122, which are configured to radiate thermal energy away from the thermally conductive portions 120. Therefore, any thermal energy which passes through the thermally insulating layer 110 and into the thermally conductive layer 112 can be removed from the thermally conductive layer 112 via the radiating fins 122 of the thermally conductive portions 120, in order to maintain a low surface temperature on the first surface of the electrical device 100.

Similarly to the first example embodiment, various configurations may be used for the thermally conductive portions 120. One or more thermally conductive portions 120 may be included, and may have various shapes, and may extend either partially or fully across the width of the electrical device 100. In one example embodiment, the first side of the electrical device 100 may be entirely covered by the thermally insulating layer 110 and thermally conductive layer 112, and all sides extending from the first side may be fully covered by thermally conductive portions 120. For example, for a cube or cuboid shaped electrical device 100, all four sides of the electrical device 100 that extend from the first side may be entirely covered by four thermally conductive portions 120. Thus, a housing may be formed around the electrical device 100 by the thermally insulating layer 110, the thermally conductive layer 112, and the thermally conductive portions 120. Further, in some example embodiments, the side opposing the first side may also be partially or fully covered by a thermally conductive portion 120 including radiating fins 122. Regardless of the configuration of the thermally conductive portions 120, each thermally conductive portion 120 may include any number of radiating fins 122, oriented in any direction. For example, although the radiating fins 122 are shown extending in the vertical direction in FIG. 5, in some example embodiments, the radiating fins 122 may extend in the horizontal direction (along the width of the device). All thermally conductive portions 120 may include radiating fins 122, or only some of the thermally conductive portions may include radiating fins.

The thermally conductive portions 120 including the radiating fins 122, such as those shown in FIG. 5, may be cooled either by a natural air flow or a forced air flow. For example, in some example embodiments, one or more cooling fans may be used as the cooler 130 (not shown in FIG. 5), with the one or more cooling fans configured to provide an air flow over the one or more radiating fins 122. In other words, the radiating fins 122 are configured or suitable for conducting heat away from the thermally conductive layer 112 via the one or more cooling fans provided externally to the electrical device. Alternatively, in some example embodiments, a natural airflow could be used to cool the radiating fins 122 and therefore the thermally conductive portions 120. In other words, a natural airflow could be used instead of a separate cooler 130.

The radiating fin configuration of the second example embodiment could be used instead of the cooling plate configuration described in the first example embodiment, or in combination with the configuration of the first example embodiment. In other words, in order to remove heat from the thermally conductive portions 120, just cooling plates could be used (as in the first example embodiment), or just radiating fins could be used (as shown in FIG. 5), which could be cooled either by a natural airflow or by one or more cooling fans, or a combination of both cooling plates and natural or forced air cooled radiating fins could be used.

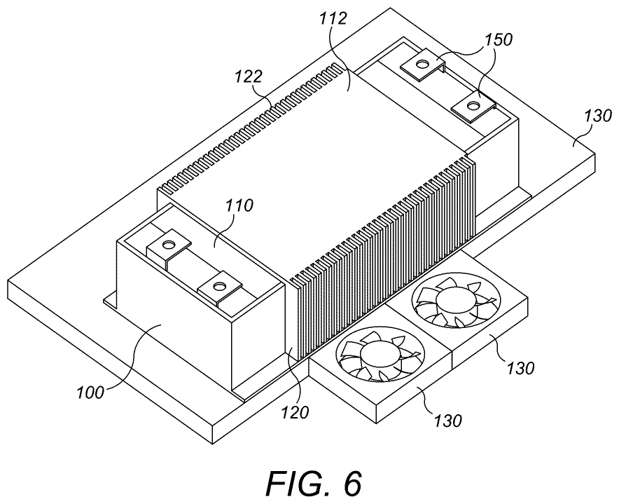

For example, FIG. 6 shows a perspective view of an electrical device 100 of a third example embodiment of the present invention. In FIG. 6, the cooler 130 includes both a cooling plate positioned on a second side of the electrical device 100 opposing the first side of the electrical device 100, and a pair of cooling fans providing an airflow over a plurality of radiating fins on a thermally conductive portion 120. Excellent cooling of the electrical device 100, and particularly the thermally conductive layer 112, can be achieved through this combination of coolers or cooling structures, ensuring a large surface temperature is prevented on the first side of the electrical device 100.

In FIG. 6, the cooler 130 includes a pair of cooling fans disposed next to a single thermally conductive portion 120 and providing an airflow directly over the radiating fins 122. However, any cooling fan configuration could be used, with any number of cooling fans being located at various positions and at various angles with respect to any of the one or more thermally conductive portions 120, provided the cooling fans provide an airflow against or over the radiating fins 122. Moreover, the radiating fins 122 may be oriented in any direction. For example, in one example embodiment, the radiating fins may extend along the width of the electrical device 100 (i.e., the horizontal direction in FIG. 6), and one or more cooling fans may be configured to provide an airflow along the width of the electrical device parallel or substantially parallel, within manufacturing and/or measurement tolerances, to the radiating fins. The one or more cooling fans may be connected to an external power supply (not shown in FIG. 6), or may draw power from the electrical device 100 itself, or a circuit that the electrical device 100 is included in.

The various modifications mentioned previously could again be made in the third example embodiment. For example, the thermally conductive portions could be extended along the entire width of the electrical device 100, and could be included on all sides of the device that extend away from the first side. Another example embodiment combining both a cooling plate and radiating fins will be discussed below in relation to FIG. 7.

FIG. 7 shows a perspective view of an electrical device 100 of a fourth example embodiment of the present invention. The same reference numerals used in FIGS. 1 to 6 are used in FIG. 7 for equivalent features. A thermally insulating layer 110 (not shown) is disposed on a first side of the electrical device 100, and a thermally conductive layer 112 is disposed on top of the thermally insulating layer 110. In the view shown in FIG. 7, the top side is the first side of the electrical device 100 which is maintained at a low temperature by the composite layer arrangement of the thermally insulating layer 110 and thermally conductive layer 112. The thermally insulating layer 110 is hidden underneath the thermally conductive layer 112 in the view shown in FIG. 7.

In the fourth example embodiment, a second side of the electrical device 100 is configured to be positioned against a cooling plate as a cooler 130 (not shown). In the view shown in FIG. 7, the second side is the rear side of the device (denoted by the label B in FIG. 7). The second side is adjacent to the first side of the electrical device 100. In other words, the second side extends perpendicularly or substantially perpendicularly, within manufacturing and/or measurement tolerances, away from the first side of the electrical device 100 in the fourth example embodiment. The electrical device 100 includes one or more thermally conductive portions 120 that are in thermal contact with the thermally conductive layer 112 and are configured or suitable to transfer heat from the thermally conductive layer 112 to the cooler 130, e.g., a cooling plate. The one or more thermally conductive portions 120 may take various forms, provided that they are in thermal connection with both thermally conductive layer 112 and the cooler 130, and form a path for heat to flow from the thermally conductive layer 112 to the cooler 130. The one or more thermally conductive portions 120 may include, or may be entirely formed from, one or more mounting elements 170 which are used to attach the electrical device 100 to the cooler 130, such as those shown in FIG. 7. Alternatively or additionally, the thermally conductive portions 120 (and flanges 160) on the third and fifth sides of the electrical device 100, which will be discussed below, may also be the thermally conductive portions 120 that are in thermal contact with both the thermally conductive layer 112 and the cooler 130. In some example embodiments, the thermally conductive layer 112 may be in direct thermal contact with the cooler 130 when positioned against the cooling plate, to allow heat to flow out of the thermally conductive layer 112.

The fourth example embodiment also includes one or more thermally conductive portions 120 that include radiating fins 122 positioned on additional sides of the device. In the fourth example embodiment, thermally conductive portions 120 are included on third, fourth and fifth sides of the device. The third, fourth, and fifth sides are adjacent to the first side of the electrical device 100 in the fourth example embodiment. In other words, the third, fourth and fifth sides extend perpendicularly or substantially perpendicularly, within manufacturing and/or measurement tolerances, away from the first side of the electrical device 100 in the fourth example embodiment. The fourth side opposes the second side. The thermally conductive portions 120 may extend either partially of fully over each of the third, fourth and fifth sides, and the one or more radiating fins 122 may extend fully or partially over each of the thermally conductive portions 120. The radiating fins 122 may be cooled as described in the previous example embodiments, with either a cooling fan acting as a cooler 130, or a natural air flow being used to cool the radiating fins. Mounting elements may be included on the third and fifth sides, such as the flanges 160 shown in FIG. 7.

The configuration of the fourth example embodiment is therefore an example embodiment where the thermally conductive portions 120, thermally insulating layer 110 and thermally conductive layer 112 are combined to form a closed housing or box around the electrical device 100, with only the second side of the electrical device 100 remaining uncovered and able to be disposed against a cooler 130.

Although the fourth example embodiment shown in FIG. 7 includes radiating fins 122 on three of the thermally conductive portions 120, and is also configured for placement against a cooling plate, variations of the fourth example embodiment are possible, as would be understood by the skilled person. For example, in some example embodiments, only thermally conductive portions 120 including radiating fins 122 may be present, and the cooling plate may be omitted. Alternatively, the radiating fins 122 may be omitted, leaving only a cooling plate as the sole cooler 130. Moreover, any number of thermally conductive portions 120 including radiating fins 122 may be used. For example, only one or two sides of the electrical device 100 may include thermally conductive portions 120 with radiating fins 122 in some example embodiments. The variations described above for the first, second, and third example embodiments are also applicable to the fourth example embodiment.

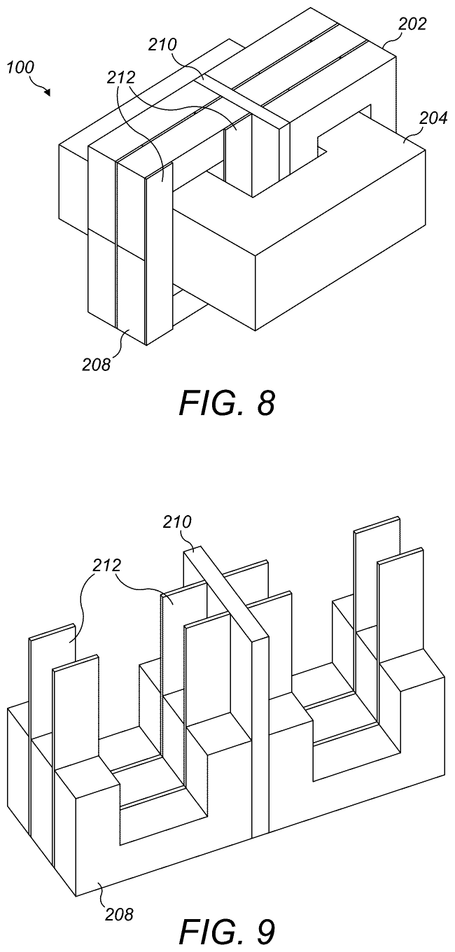

The composite layer arrangement in the above-described example embodiments, could be applied to any type of transformer or inductor. For example, any of the transformer arrangements described in UK patent applications GB2011747.9 and GB2011332.0 could be used, as will be discussed below with reference to FIGS. 8 to 14.

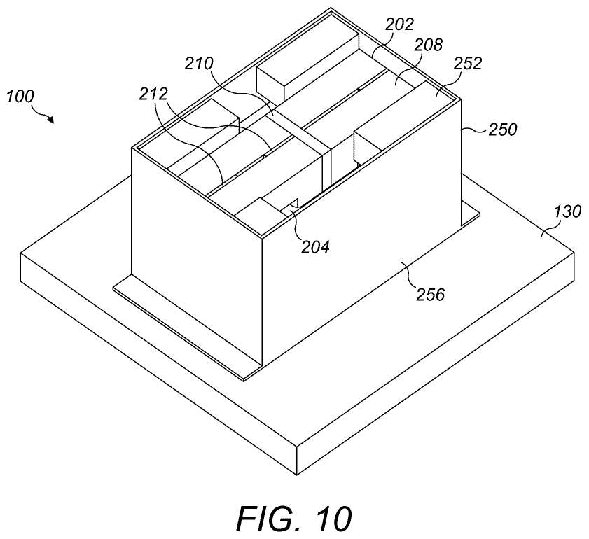

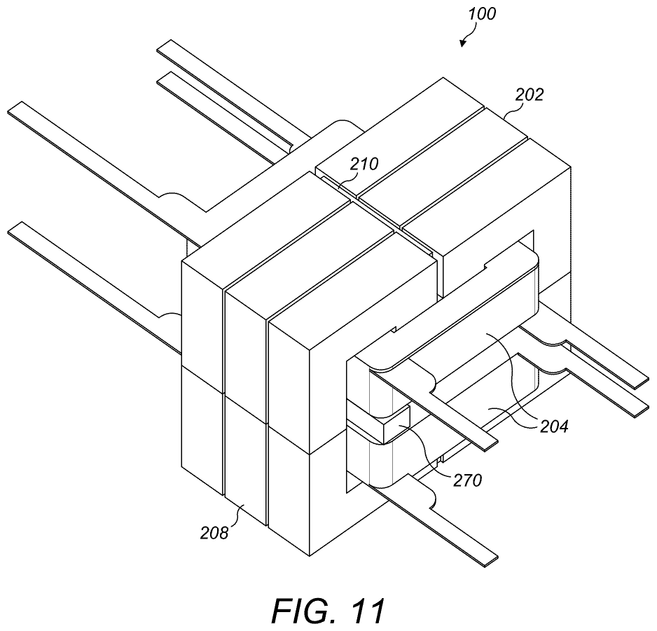

FIGS. 8 and 10 show examples of interior structures that may be used in the electrical devices 100 of any of the previous example embodiments (FIGS. 1 to 7). FIG. 9 shows a partial view of FIG. 8. The electrical devices 100 of FIGS. 8 and 10 each include a core assembly 202 and windings 204. The windings 204 are wrapped around the core assembly 202. A single-phase shell-type transformer is shown in FIGS. 8 and 10; however, multiphase shell-type transformers and multiphase core-type transformers may also be used.

The core assemblies 202 of FIGS. 8 and 10 include UU type cores constructed from a number of U-shaped cores 208, twelve in the case of FIG. 8, and eight in the case of FIG. 10. Two of the U-shaped cores are not shown in FIG. 8 to provide a view of the primary and secondary thermally conductive plates 210, 212, which will be discussed later. UI type cores could also be used as an alternative, or in combination with UU type cores of the core assemblies 202. The U-shaped cores are combined to create a closed core. Two closed cores are then combined to construct a core layer. When only U-shaped cores are used, each core layer will include four U-shaped cores. Three of these core layers are then stacked to create the core assembly in FIG. 8; however, more or less than three layers could be used. For example, two layers are used in FIG. 10. The U-shaped cores 108 are made from a magnetic material such as a ferrite material.

The core assemblies 202 each further include a primary thermally conductive plate 210 and may optionally include one or more secondary thermally conductive plates 212. The primary and secondary thermally conductive plates 210, 212 are preferably made from a material with a high thermal conductivity that will not disrupt the magnetic properties of the transformer. For example, a non-magnetic metal could be used, such as aluminum or copper.

FIG. 9 shows a cutaway view of the core assembly and thermally conductive plate arrangement of FIG. 8 in more detail. In FIG. 9, the windings 204 and the two upper U-shaped cores 208 from each core layer have been removed for illustrative purposes, leaving only the six lower U-shaped cores 208 and the primary and secondary thermally conductive plates 210, 212 remaining.

The primary thermally conductive plate 210 is disposed between adjacent U-shaped cores 208, so as to pass through the center of the windings 204 along the axial direction of the windings and bisect the core layers created by the sets of four U-shaped cores. The one or more secondary thermally conductive plates 212 are disposed between adjacent U-shaped cores, between the core layers, in a plane orthogonal or substantially orthogonal to the plane of the primary thermally conductive plate 210 and parallel or substantially parallel the axial direction of the windings. The primary and secondary thermally conductive plates 210, 212 are positioned in planes which are parallel or substantially parallel to the magnetic field inside the core, so as to have no effect on the magnetic circuit.

The thermally conductive plates transfer heat away from the interior of the core assembly 202 via conduction. Heat removed from the interior of the electrical device 100 may be transferred to the coolers, including, for example, the cooling plate and/or radiating fins, of any of FIGS. 1 to 7. The heat may be transferred from the thermally conductive plates 210, 212 to the thermally conductive portions 120, or from the thermally conductive plates 210, 212 directly to the cooler 130. For example, FIG. 10 shows the electrical device 100 mounted on a cooling plate acting as the cooler 130. Heat from the primary and secondary thermally conductive plates 210, 212 may be removed via the cooler 130.

A primary thermally conductive plate 210 may be used alone without the secondary thermally conductive plates 212. Alternatively, secondary thermally conductive plates 212 may be included both adjacent to the primary thermally conductive plate 210 and adjacent to the outer edge of the core assembly 202. In some example embodiments, only some of the secondary thermally conductive plates 212 may be included, for example, only the secondary thermally conductive plates 212 adjacent to the primary thermally conductive plate 210 may be included, and the secondary thermally conductive plates 212 adjacent to the outer edge of the core assembly 202 may be omitted, or vice versa. In some example embodiments, the secondary thermally conductive plates may be thinner than the primary thermally conductive plate. Addition of the secondary conductive plates 212 can increase the amount of heat extracted from the core compared to the primary thermally conductive plate 210 alone, due to the increased contact area with the U-shaped cores 208.

Aluminum is typically used for constructing the thermally conductive plates 210, 212; however, aluminum plates can be substituted with copper plates in space critical applications for the further improvement of the efficacy. Aluminum typically has a thermal conductivity of over fifty times that of the core material, and copper typically has a thermal conductivity nearly 100 times larger than the core material. A combination of various different materials may be used for the primary and secondary thermally conductive plates in a single core assembly 202.

The introduction of the thermally conductive plates 210, 212 improves the effectiveness of the thermal management of the transformer device significantly. For example, the hot spot temperature of the core can be reduced by more than 20° C. by the thermally conductive plates 210, 212. Removing heat produced in the core assembly 202 can prevent heat being transferred from the core to the windings, and therefore can also prevent the winding temperature increasing. The improved thermal management of the core assembly can prevent failure of the electrical device and allow further miniaturization of the electrical device, as well as preventing degradation of the magnetic properties of the core.

In the case of a multiphase transformer, multiple primary thermally conductive plates could be used. Each core layer would include more than four U-shaped cores, increasing by two U-shaped cores with each extra phase, and the primary thermally conductive plates would pass through each core layer a number of times, between each pair of closed cores. A multitude of secondary plates could be disposed between the core layers.

A number of different winding arrangements could be used for the windings 204. For example, round wire windings or flat wire windings may be used. The windings may be formed from square or substantially square turns. The windings 204 include input and output terminals extending orthogonally or substantially orthogonally to the one or more core layers (not shown). The windings may be Murata Manufacturing Co., Ltd.'s pdqb type windings, as detailed in UK patent publication GB2574481.

Alternatively, other winding arrangements could be used. More than one set of windings may be used as the windings 104, and each set of windings may contain a number of different coils, for example a primary and secondary coil, or may instead contain a single coil. The windings 204 may electrically insulated through various techniques such as coating the windings or encasing the windings in a cast resin or the like. The windings could also be electrically insulated through the use of Kapton® tape or the like.

FIG. 10 also includes a thermally conductive housing 250 with four corner beams 252 and an outer casing 256, which surround the core assembly 202 and windings 204. A portion of one of the corner beams 252 and the upper face of the outer casing 256 have been omitted in the view of FIG. 10 to allow the interior of the transformer to be seen. This thermally conductive housing 250 may be used with any of the example embodiments of FIGS. 1 to 7.

In the example embodiment shown in FIG. 10, the electrical device 100 is mounted on a cooling plate as the cooler 130. The primary thermally conductive plate 210, one or more secondary thermally conductive plates 212, and U-shaped cores 208 are in contact with the cooler 130 at one end, to allow heat to be removed from the interior of the electrical device 100. The corner beams 252 and outer casing 256 are also placed in contact with the cooler 130 to allow heat to be removed from the thermally conductive housing 250. In the example embodiment shown in FIG. 10, the corner beams 252 are in thermal contact with the U-shaped cores 208. The outer pair of the secondary thermally conductive plates and corresponding outer surfaces of the U-shaped cores 208 are in contact with the outer casing 256. The corner beams 252 may extend higher above the cooler 130 than the core assembly 202, so that the thermally conductive plates 210, 212 and U-shaped cores 208 do not contact the upper face of the outer casing 256. This prevents an electrically conducting path being created through the electrical device 100 via the thermally conductive plates 210, 212, which could lead to shorting due to voltages induced by leakage magnetic fields.

As described previously, any surface of the electrical device 100 may be chosen as the surface to keep at a low temperature, using the thermally insulating layer 110 and the thermally conductive layer 112. When the electrical device 100 of FIG. 10 is used in the first example embodiment of FIGS. 1 and 2, the thermally insulating layer 110 would be located on the top (first) side of the electrical device 100, opposite to the cooler 130 (disposed on the second side). The thermally insulating layer 110 would prevent heat transfer to the first surface of the electrical device 100, including preventing any heat removed by the primary and secondary thermally conductive plates 210, 212 from flowing upwards towards the first surface of the electrical device 100. Instead heat flow will be predominantly in the downwards direction in FIG. 10, towards the cooler 130, and any heat which does pass through the thermally insulating layer 110 could be transferred from the thermally conductive layer 112 to the cooler 130 by one or more thermally conductive portions 120 as described previously.

The interior structure of the electrical device 100 described in FIGS. 8 to 10 may be summarized as a device including one or more sets of windings, and a core assembly. The core assembly includes: one or more core layers, wherein each core layer includes two closed cores, and each closed core is constructed from either two U-shaped cores or from a U-shaped core and an I-shaped core; and a thermally conductive plate that is disposed between the closed cores along the axial direction of the one or more sets of windings, so as to bisect the one or more core layers. Each set of windings passes through each of the closed cores. The thermally conductive plate is in thermal contact with the closed cores to transfer heat away from the interior of the core assembly.

Various other internal cooling arrangements could be used in the electrical device 100 in combination with the described composite layer disposed on the first outer surface. For example, FIG. 11 shows the interior transformer arrangement of FIG. 8 with a pair of additional thermally conductive plates 270 (hereinafter referred to as thermally conductive blocks 270) disposed against the windings 204 and configured to transfer heat away from the windings.

In FIG. 11 the pair of thermally conductive blocks 270 are disposed between two sets of windings 204, adjacent to and in thermal contact with the windings 204. Alternatively, only one set of windings may be used, with the thermally conductive blocks 270 positioned adjacent to one side of the windings, or placed within the windings between two turns. The thermally conductive blocks 270 extend orthogonally or substantially orthogonally, within manufacturing and/or measurement tolerances, to the axial direction of the windings. The thermally conductive blocks 270 are in thermal contact with the windings 204 to transfer heat away from the windings.

The example embodiment of FIG. 11 includes two thermally conductive blocks 270, only one of which can be seen in the view shown in FIG. 11. The second thermally conductive block 270 is positioned on the rear side of the electrical device 100. In other words, the thermally conductive blocks 270 are positioned on opposite sides of the device in a rotationally symmetric fashion about the winding axis of the one or more sets of windings. Other arrangements could be used, as would be understood by the skilled person. For example, a single thermally conductive block 270 may be used instead however, or a plurality of thermally conductive blocks may be used, for example, four thermally conductive blocks 270 all extending perpendicular or substantially perpendicular, within manufacturing and/or measurement tolerances, to each other could be used.

The thermally conductive blocks 270 remove heat from the windings in a similar fashion to the thermally conductive plates 210, 212 and the core assembly 202 of FIGS. 8 to 10. These thermally conductive blocks 270 provide low thermal resistance paths for the heat generated in the windings to flow away from the device interior. Heat removed from the interior of the electrical device 100 by the thermally conductive blocks 270 may be transferred to the coolers, including, for example, the cooling plate and/or radiating fins, of any of FIGS. 1 to 7, for example, by thermal contact between the thermally conductive blocks 270 and coolers 130, or between the thermally conductive blocks 270 and the thermally conductive portions 120. The thermally conductive blocks 270 may be made of a similar thermally conductive non-magnetic material as used for the thermally conductive plates of the previous example embodiments.

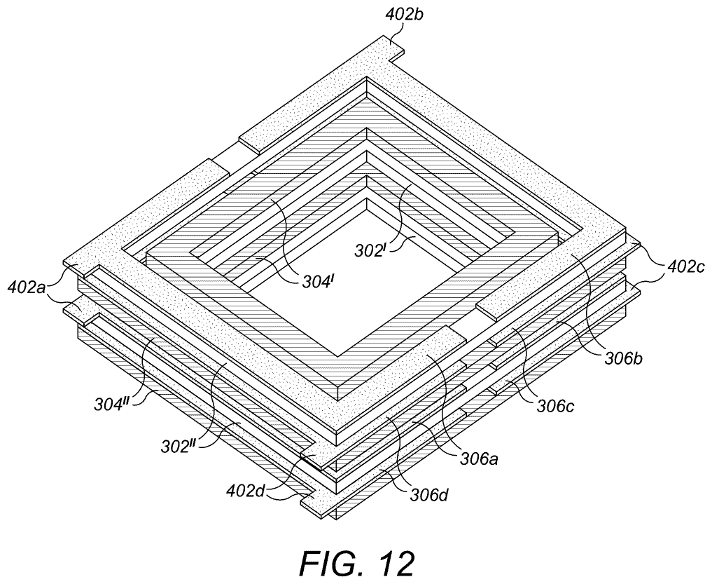

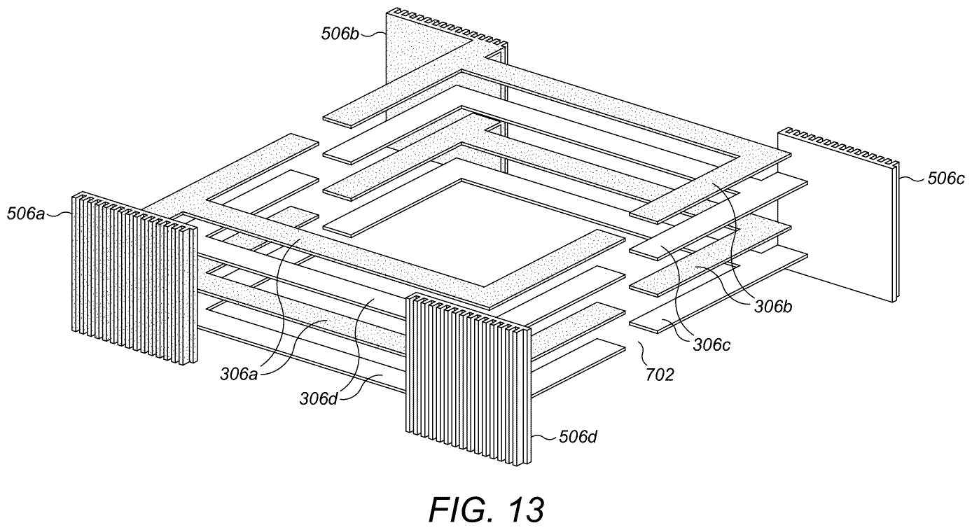

Alternative, more sophisticated winding cooling arrangements could also be used in the electrical device, such as those outlined in UK patent application GB2011332.0 and discussed in relation to FIGS. 12 to 14 below.

FIGS. 12 to 14 show examples of interior structures that may be used in the electrical devices 100 of any of the previous example embodiments (FIGS. 1 to 7). In particular, FIG. 12 shows a cooling plate arrangement for the windings 204 in a transformer. The windings include a first coil or winding 302 including a plurality of turns, a second coil or winding 304 including a plurality of turns, and a plurality of thermally conductive plates 306. These three groups of components are distinguished by the three different shadings in FIG. 12. The first and second coils may be the primary and secondary coils of the transformer.

In the example shown in FIG. 12, each of the first coil 302 and the second coil 304 includes four sets of turns, two inner sets of turns 302′, 304′ and two outer sets of turns 302″, 304″. Each set of turns may include one or more individual turns (not shown in FIG. 12). The outer sets of turns 302″, 304″ of both the first coil 302 and second coil 304 include a first diameter, and the inner sets of turns 302′, 304′ of both the first coil 302 and second coil 304 include a second diameter. The first diameter is larger than the second diameter. The sets of turns of the first coil are interleaved with the sets of turns of the second coil. The sets of turns of a given coil are connected to create a continuous winding. Each of the first and second coil 302, 304 alternate between the inner and outer sets of turns as the winding of each coil is traversed. In other words, the sets of turns of the first coil 302 alternate between having the first diameter and the second diameter, and the sets of turns of the second coil 304 alternate between having the second diameter and the first diameter. This winding configuration is an example of Murata Manufacturing Co., Ltd.'s pdqb windings, as detailed in UK patent publication GB2574481. Such winding arrangements may be used to mitigate high frequency losses due to the proximity effect. The details of the interconnections between each set of turns have been omitted from FIG. 12 for simplicity.

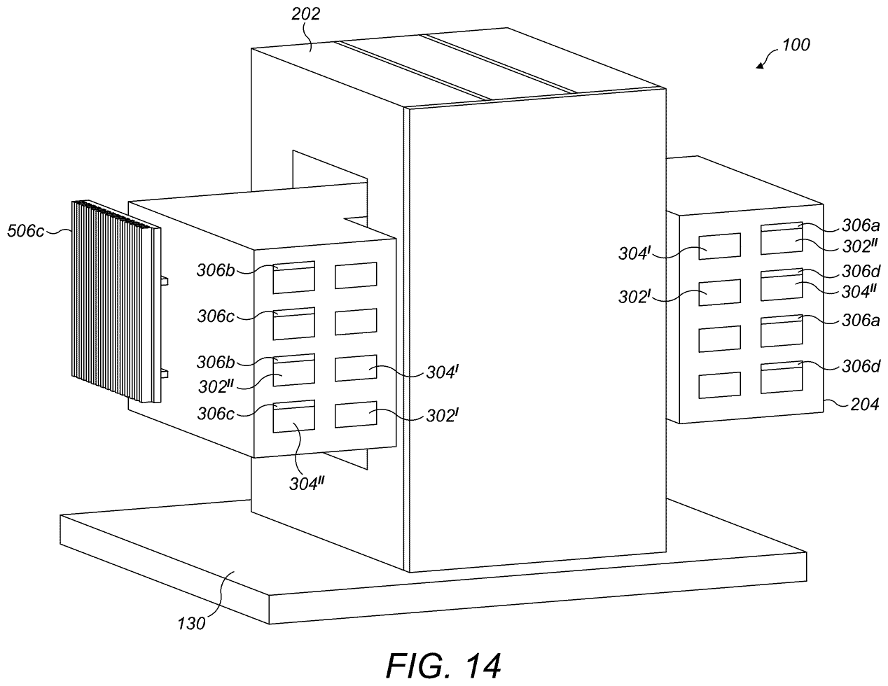

The plurality of thermally conductive plates 306 are split into a first set of thermally conductive plates 306a, 306b and a second set of thermally conductive plates 306c, 306d. The first set of thermally conductive plates 306a, 306b is interleaved with the sets of turns of the first coil 302, with each plate disposed adjacent to one of the sets of turns of the first coil. The second set of thermally conductive plates 306c, 306d is interleaved with the sets of turns of the second coil 304, with each plate disposed adjacent to one of the sets of turns of the second coil. The thermally conductive plates 306 are made of a material with a high thermal conductivity that will not disrupt the magnetic properties of the transformer; for example, a non-magnetic metal could be used, such as aluminum of copper. The thermally conductive plates 306 transfer heat away from the first and second coil via conduction. Heat removed from the windings by the thermally conductive plates 306 may be transferred to the cooling plate and/or radiating fins of any of FIGS. 1 to 7. For example, the connection portions 402 may thermally connect the thermally conductive plates 306 to the cooler 130 or thermally conductive portions 120 of the example embodiments of FIGS. 1 to 7. Alternatively, as shown in FIGS. 13 and 14, the thermally conductive plates 306 and connection portions 402 may be attached to their own independent radiating elements 506.

FIG. 13 shows the arrangement of the thermally conductive plates 306 from the example embodiment of FIG. 12 in isolation. The first set of thermally conductive plates 306a, 306b which are placed adjacent to the first coil 302 are shaded in FIG. 13, and the second set of thermally conductive plates 306c, 306d which are placed adjacent to the second coil 304 are not shaded. The first set of thermally conductive plates 306a, 306b is connected to a first set of radiating elements 506a, 506b and the second set of thermally conductive plates 306c, 306d is connected to a second set of radiating elements 506c, 506d, so that the first set of thermally conductive plates and second set of thermally conductive plates are electrically isolated from each other. Ensuring that each of the first set 306a, 306b and second set 306c, 306d of thermally conductive plates are electrically isolated from each other helps prevent any electrical shorting from occurring between the first coil and the second coil. The thermally conductive plates 306 may instead be thermally connected to the thermally conductive portions 120 and/or cooling plate of any of FIGS. 1 to 7.

Furthermore, in FIG. 13 each plate of the first and second sets of thermally conductive plates is split into two sections electrically isolated from each other, with gap portions 702 separating the two sections. Each plate of the first set of thermally conductive plates 306a, 306b is partitioned into a first section 306a and a second section 306b. Each plate of the second set of thermally conductive plates 306a, 306b is similarly partitioned into a first section 306c and a second section 306d. Such an arrangement means that the sections of the thermally conductive plates are not electrically connected, to prevent a low resistance electrical path from being formed (in other words, preventing the thermally conductive plates from acting like a shorted turn), which could lead to a failure of the electrical device. When the independent radiating elements 506 are used as shown in FIG. 13, four separate electrically and thermally conductive paths are made through the connections of the thermally conductive plates 306 and the radiating elements 506, to ensure electrical isolation.

FIG. 14 shows a cross section through a transformer including a core assembly 202 and windings 204 including the winding arrangement of FIGS. 12 and 13. The placement of the first set of thermally conductive plates 306a, 306b against the first coil 302, and the second set of thermally conductive plates 306c, 306d against the second coil 304 can be seen in FIG. 14. Electrical insulation is included between the coils and the thermally conductive plates. The entire winding arrangement (the first coil 302, the second coil 304 and the first and second sets of thermally conductive plates 306) are encased in a resin dielectric material.

The transformer shown in FIG. 14 may be used in the interior of the electrical device 100 of any of the example embodiments of FIGS. 1 to 7. For example, in FIG. 14, the electrical device 100 is mounted on a cooler 130, and the top side (first side) of the electrical device 100 of FIG. 14 could be kept at a low temperature by the composite layer arrangement of the thermally insulating layer 110 and thermally conductive layer 112. The thermally conductive plates 306 allow heat to be removed from the windings and therefore from the interior of the electrical device 100. The independent radiating elements 506 may be used, or the heat removed from the windings by the thermally conductive plates 306 could be transferred to the coolers, including, for example, the cooling plate and/or radiating fins, of the example embodiments of FIGS. 1 to 7. In other words, the heat may be transferred from the thermally conductive plates 306 to the thermally conductive portions 120, or from the thermally conductive plates 306 directly to the cooler 130.

The interior structure of the electrical device 100 described in FIGS. 12 to 14 may be summarized as a winding assembly for a transformer including: a first coil and a second coil, each including a plurality of sets of turns, wherein each set of turns includes one or more individual turns; a first set and a second set of thermally conductive plates; and a resin dielectric material. The plurality of sets of turns of the first coil are interleaved with the plurality of sets of turns of the second coil; the first set of thermally conductive plates is interleaved with the sets of turns of the first coil, with each plate disposed adjacent to one of the sets of turns of the first coil, to transfer heat away from the first coil; the second set of thermally conductive plates is interleaved with the sets of turns of the second coil, with each plate disposed adjacent to one of the sets of turns of the second coil, to transfer heat away from the second coil; the first coil, the second coil and the first and second sets of thermally conductive plates are encased in the resin dielectric material, to electrically insulate the first coil and the second coil.

Various modifications can be made to the example embodiments of the present invention, as would be understood by the skilled person. For example, the described composite layer arrangement could be included on more than one surface of the electrical device 100. In other words, a thermally insulating layer 110 and thermally conductive layer 112 could each be disposed on multiple surfaces of the electrical device 100, in order to maintain the surface temperature of the multiple chosen surfaces of the electrical device 100 at a low value. However, the more surfaces that are maintained at a low temperature using the composite layer arrangement, the more heat will be trapped inside the electrical device 100. Therefore, the number of sides of the device which may be covered by a composite layer is limited by the restraints on the maximum allowable temperature within the electrical device 100.

The composite layer arrangement may be applied to any high-power, high-frequency transformer or any high-power inductor application where the control of the surface temperature is important. Any of the interior structures discussed in relation to FIGS. 8 to 14 could be used in the electrical device 100. The cooling plate arrangements of any of FIGS. 8 to 11 could be used separately to, or in combination with, the cooling plate arrangements of any of FIGS. 12 to 14. The composite layer may also be used in any power electronics enclosing arrangement where surface temperature is desired to be maintained at a low level.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electrical device comprising:
a thermally insulating layer including a first surface and a second surface opposing the first surface, the first surface of the thermally insulating layer being located on a first surface of the electrical device;
a thermally conductive layer on the second surface of the thermally insulating layer; and
one or more thermal conductors in thermal contact with the thermally conductive layer to transfer heat away from the thermally conductive layer via one or more coolers external to the electrical device; wherein
the electrical device is a transformer or an inductor.

2. The electrical device of claim 1, wherein
the one or more coolers include a cooling plate on a second surface of the electrical device; and
at least one of the one or more thermal conductors is in thermal contact with the cooling plate to conduct heat away from the thermally conductive layer to the cooling plate.

3. The electrical device of claim 2, wherein the second surface of the electrical device opposes the first surface of the electrical device.

4. The electrical device of claim 3, wherein the one or more thermal conductors are positioned on one or more surfaces of the electrical device that extend between the first surface and the second surface of the electrical device.

5. The electrical device of claim 3, wherein the one or more thermal conductors includes two thermal conductors on opposing surfaces of the electrical device that both extend between the first surface and the second surface.

6. The electrical device of claim 2, wherein the electrical device and/or at least one of the one or more thermal conductors include one or more mounts to fix the electrical device onto the cooling plate.

7. The electrical device of claim 1, wherein at least one of the one or more thermal conductors include one or more radiating fins.

8. The electrical device of claim 7, wherein the one or more coolers include a cooling fan to provide an air flow over the one or more radiating fins.

9. The electrical device of claim 1, wherein the one or more thermal conductors are positioned on one or more surfaces of the electrical device that extend perpendicularly or substantially perpendicularly away from the first surface of the electrical device.

10. The electrical device of claim 1, further comprising:
an additional thermally insulating layer including a first surface and a second surface opposing the first surface of the additional thermally insulating layer, the first surface of the additional thermally insulating layer being located on a third surface of the electrical device; and
an additional thermally conductive layer on the second surface of the additional thermally insulating layer; wherein
the additional thermally conductive layer is in thermal contact with the one or more thermal conductors and/or one or more additional thermal conductors to transfer heat away from the additional thermally conductive layer.

11. The electrical device of claim 1, wherein the electrical device has a cuboid or cube shape.

12. The electrical device of claim 1, wherein the thermally insulating layer is equal in size to or larger in size than the thermally conductive layer.

13. The electrical device of claim 1, wherein the thermally insulating layer and the thermally conductive layer substantially cover an entirety of the first surface of the electrical device.

14. The electrical device of claim 1, wherein the thermally conductive layer and/or the one or more thermal conductors include a metal, a non-magnetic metal, aluminum, or copper.

15. The electrical device of claim 1, wherein the thermally conductive layer is thinner than at least one of the one or more thermal conductors.

16. The electrical device of claim 1, wherein the thermally insulating layer is electrically insulating.

17. The electrical device of claim 1, wherein the thermally insulating layer includes at least one of plastic, fiberglass, resin, or a glass-reinforced epoxy laminate.

18. The electrical device of claim 1, wherein the electrical device includes a high-power, high-frequency transformer.

19. The electrical device of claim 1, further comprising:
a core assembly; and
one or more thermally conductive plates within the core assembly to transfer heat away from the interior of the core assembly.

20. The electrical device of claim 1, further comprising:
a winding assembly; and
one or more thermally conductive plates within the winding assembly to transfer heat away from the winding assembly.

21. A housing for an electrical device comprising:
a first surface including:
a thermally insulating layer including a first surface and a second surface opposing the first surface; and
a thermally conductive layer on the second surface of the thermally insulating layer; and
one or more thermal conductors that are in thermal contact with the thermally conductive layer to transfer heat away from the thermally conductive layer via a cooler external to the electrical device; wherein
the housing is structured to accommodate the electrical device, with the first surface of the thermally insulating layer against a first surface of the electrical device; and
the electrical device is a transformer or an inductor.
